(19) United States
(12) Patent Application Publication
(10) Pub. No.: US 2021/0302966 A1
(43) Pub. Date: Sep. 30, 2021

(54) AUTONOMOUS AQUATIC VEHICLES, SYSTEMS, AND METHODS FOR AQUATIC ENVIRONMENT MONITORING

(71) Applicant: George Mason University, Fairfax, VA (US)

(72) Inventors: Feitian Zhang, Fairfax, VA (US); Pei Dong, Fairfax, VA (US); Qiliang Li, Fairfax, VA (US)

(21) Appl. No.: 17/204,990

(22) Filed: Mar. 18, 2021

Related U.S. Application Data
(60) Provisional application No. 62/994,335, filed on Mar. 25, 2020.

(51) Int. Cl. G05D 1/02; G01C 21/20; B63B 49/00; G01C 13/00

(52) U.S. Cl. CPC G05D 1/0206; G01C 21/203; B63H 2025/045; G01C 13/00; B63B 49/00

(57) ABSTRACT

Aquatic environment monitoring devices, systems and methods are provided. An aquatic vehicle includes a body supporting a drive sub-system configured to drive the aquatic vehicle along a travel path, at least one sensor configured to obtain a plurality of sensor data points at a plurality of different locations along the travel path, a GPS module configured to track movement of the aquatic vehicle along the travel path, and a microcontroller configured to compile the sensor data points with GPS location data corresponding to a location where each of the sensor data points was obtained. A remote computer is configured to receive the compiled data from the microcontroller and, based thereon, provide an output correlating the sensor data points with the GPS location data.

### CROSS-REFERENCE TO RELATED APPLICATIONS

This application claims the benefit of U.S. Provisional Patent Application No. 62/994,335 filed on Mar. 25, 2020 and titled “SELF-SUSTAINING UNMANNED SURFACE VEHICLE FOR AQUATIC ENVIRONMENT MONITORING,” the entire contents of which are hereby incorporated herein by reference.

### FIELD

The present disclosure relates to the monitoring of aquatic environments and, more specifically, to autonomous aquatic vehicles, system, and methods for monitoring aquatic environments.

### BACKGROUND

Various different types of information relating to aquatic environments are utilized in order to better understand the aquatic environments, e.g., to assess the ecosystem, to facilitate the study and/or protection of aquatic life, to monitor potential environmental harms and/or environmental damage, to monitor changes over time and potential causes thereof, for surveying purposes, for regulatory compliance, and/or for other purposes.

Conventional approaches for obtaining information relating to aquatic environments rely on manual testing and/or depend on satellite observation. Manual testing requires extensive labor by a scientist(s) and is limited to the locations in and around the aquatic environment that are readily accessible by the scientist(s). Satellite observation, on the other hand, is limited to information that can be gleaned from remote observation; however, even that information is only obtainable after post-image processing which leads to low resolution and time delay in obtaining the information.

### SUMMARY

The terms “about,” substantially,” and the like, as utilized herein, are meant to account for manufacturing, material, environmental, use, and/or measurement tolerances and variations, as well as other tolerances and/or variations, and in any event may encompass differences of up to 10%. Further, to the extent consistent, any of the aspects described herein may be used in conjunction with any or all of the other aspects described herein.

Provided in accordance with aspects of the present disclosure is an aquatic environment monitoring system, including an aquatic vehicle and a remote computer. The aquatic vehicle includes a body supporting a drive sub-system configured to drive the aquatic vehicle along a travel path, at least one sensor configured to obtain a plurality of sensor data points at a plurality of different locations along the travel path, a GPS module configured to track movement of the aquatic vehicle along the travel path, and a microcontroller including a processor and memory storing instructions to be executed by the processor. The microcontroller is configured to compile the sensor data points with GPS location data corresponding to a location where each of the sensor data points was obtained, and to transmit the compiled data. The remote computer includes a processor and memory storing instructions to be executed by the processor. The remote computer is configured to receive the compiled data and process the compiled data to provide an output correlating the sensor data points with the GPS location data.

In an aspect of the present disclosure, the output is a visual output, e.g., a map.

In another aspect of the present disclosure, the at least one sensor includes a sonar sensor and the sensor data points are sonar data points. In such aspects, the output may include a bathymetry map.

In still another aspect of the present disclosure, the at least one sensor includes at least one of: a pressure sensor, an oxygen concentration sensor, an air temperature sensor, or a water temperature sensor, and the sensor data points are at least one of: pressure data points, oxygen concentration data points, air temperature data points, or water temperature data points, respectively.

In yet another aspect of the present disclosure, the output includes a map illustrating sensor data point values at corresponding GPS locations.

In still yet another aspect of the present disclosure, the system further includes a remote controller configured to enable a user to remotely manually control the drive system to drive the aquatic vehicle at a desired speed and direction to define the travel path.

In another aspect of the present disclosure, the travel path is pre-determined wherein the microcontroller is configured to control the drive sub-system in accordance with GPS feedback data from the GPS module to autonomously drive the aquatic vehicle along the travel path.

In another aspect of the present disclosure, the travel path may be pre-determined by a plurality of user-input waypoints.

In yet another aspect of the present disclosure, the travel path is determined by the microcontroller or the remote computer based on a user-input corresponding to a desired area to be monitored, and the microcontroller is configured to control the drive sub-system in accordance with GPS feedback data from the GPS module to autonomously drive the aquatic vehicle along the determined travel path. In such aspects, the travel path may be determined by a plurality of generated waypoints.

In still another aspect of the present disclosure, the system further includes at least one power source disposed on the body of the aquatic vehicle for powering the aquatic vehicle. The at least one power source may include a primary and secondary power source and/or at least one solar panel.

In still yet another aspect of the present disclosure, the drive sub-system includes at least one thruster, at least one motor configured to drive the at least one thruster, and at least one drive controller configured to control the at least one motor.

A method of aquatic environment monitoring provided in accordance with aspects of the present disclosure includes driving an aquatic vehicle along a travel path, sensing a plurality of sensor data points at a plurality of different locations along the travel path, tracking movement of the aquatic vehicle along the travel path, compiling the sensor data points with GPS location data corresponding to a location where each of the sensor data points was obtained, transmitting the compiled data from the aquatic vehicle to a remote computer, receiving the compiled data at the remote computer, and processing the compiled data at the remote computer to provide an output correlating the sensor data points with the GPS location data.

In an aspect of the present disclosure, providing the output includes generating a map illustrating sensor data point values at corresponding GPS locations.

In another aspect of the present disclosure, the plurality of sensor data points represent at least one of: sonar data, pressure data, oxygen concentration data, air temperature data, or water temperature data.

In still another aspect of the present disclosure, driving the aquatic vehicle includes receiving instructions from a remote controller to drive the aquatic vehicle at a desired speed and direction to define the travel path.

In yet another aspect of the present disclosure, driving the aquatic vehicle includes autonomously driving the aquatic vehicle along the travel path using GPS feedback data and at least one of pre-determined waypoints or generated waypoints.

### BRIEF DESCRIPTION OF THE DRAWINGS

Various aspects and features of the present disclosure are described hereinbelow with reference to the drawings wherein:

FIGS. 1A-1D are perspective, top, side, and end views of an autonomous aquatic vehicle for aquatic environment monitoring provided in accordance with aspects of the present disclosure;

FIG. 2 is a schematic illustration of an aquatic environment monitoring system provided in accordance with the present disclosure;

FIG. 3 is a block diagram illustrating the system architecture of the system of FIG. 2;

FIG. 4 is a graphical representation of the autonomous aquatic vehicle of FIGS. 1A-1D following a travel path in accordance with the present disclosure;

FIG. 5 is a flow diagram of an autonomous control method for controlling the autonomous aquatic vehicle of FIGS. 1A-1D in accordance with the present disclosure;

FIG. 6 is a flow diagram of a manual control method for controlling the autonomous aquatic vehicle of FIGS. 1A-1D in accordance with the present disclosure;

FIG. 7 is a map illustrating a travel path of the autonomous aquatic vehicle of FIGS. 1A-1D within an aquatic environment in accordance with the present disclosure;

FIG. 8 is a flow diagram of a method of sonar mapping of an aquatic environment utilizing the system of FIG. 2 in accordance with the present disclosure;

FIG. 9 is a bathymetry map of an aquatic environment obtained via sonar mapping utilizing the system of FIG. 2 in accordance with the present disclosure; and

FIGS. 10-13 are oxygen concentration, pressure, air temperature, and water temperature maps, respectively, of an aquatic environment obtained via sonar mapping utilizing the system of FIG. 2 in accordance with the present disclosure.

### DETAILED DESCRIPTION

Autonomous aquatic vehicles, system, and methods provided in accordance with the present disclosure enable manual or autonomous travel of an aquatic vehicle to various different locations in and/or around an aquatic environment to: enable one or more on-board sensors of the aquatic vehicle to capture information at each of the various different locations; enable on-board test equipment to perform one or more tests at each of the various different locations; and/or enable sampling equipment to obtain one or more samples, e.g., water samples, at each of the various different locations. As result, a desired portion of the aquatic environment, a substantial portion of the aquatic environment, or substantially all of the aquatic environment can be studied and/or mapped to provide location-specific insights as to one or more features or conditions of the aquatic environment (or portion thereof) such as, for example: bathymetry, air temperature, water temperature, pressure, oxygen concentration, water pH, concentration of other chemical elements and/or compounds, the presence and/or concentration of one or more different types of biological matter, one or more properties of water and/or soil, still and/or video images, audio recordings, etc. Thus, a complete assessment of the aquatic environment (or portion thereof) can be achieved without the need to generalize and/or extrapolate information obtained from limited locations in and/or around the aquatic environment (or portion thereof) to the entire aquatic environment (or portion thereof), which could lead to error; without extensive data-collection labor by a scientist(s); and without significant delay in the reporting of collected data. Other advantages of the autonomous aquatic vehicles, system, and methods of the present disclosure will be apparent to persons of ordinary skill in the art in view of the following description.

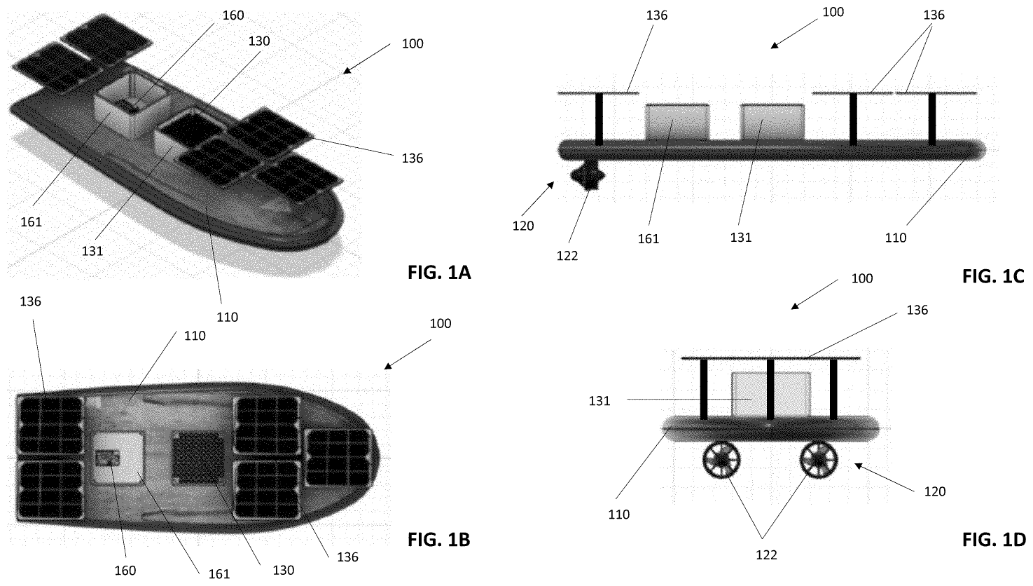

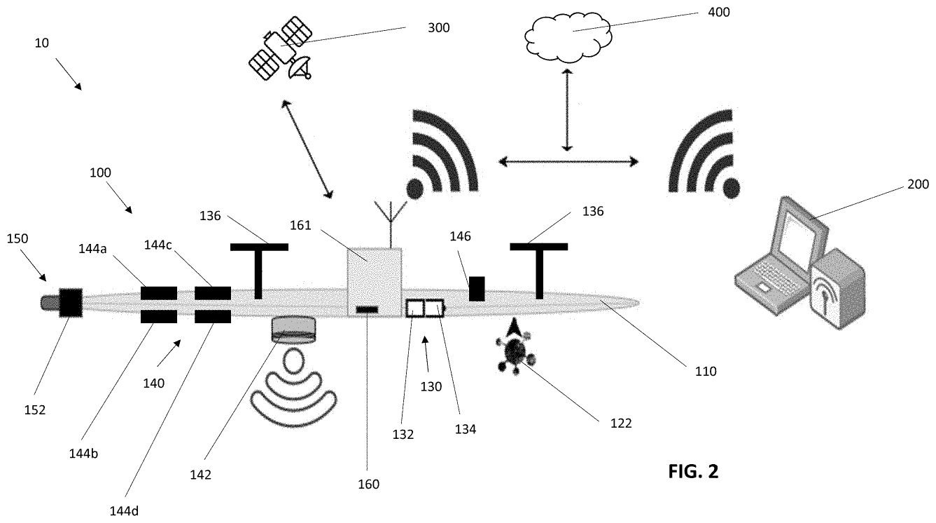

Referring to FIGS. 1A-3, and initially to FIG. 2, an aquatic environment monitoring system 10 provided in accordance with the present disclosure includes an aquatic vehicle 100 and remote computer 200. Aquatic vehicle 100 and/or remote computer 200 may be configured to communicate with a satellite 300, e.g., a GPS satellite, imaging satellite, or other suitable satellite, a cloud device 400, e.g., a cloud computer, server, network, etc., and/or other devices such as, for example: other aquatic vehicles, drones or other aircraft, UI control devices (e.g., remote controls), etc. These devices may thus form part of system 10. In aspects, remote computer 200 is replaced with a cloud device 400 or other suitable computing device whether in one physical location or part of a network of computing devices.

The various communications between aquatic vehicle 100, remote computer 200, satellite 300, cloud device 400, and/or other devices may be made via Bluetooth, Bluetooth low energy, Zigbee, IEEE 802.11, a Wireless Local Area Network (WLAN), a Wireless Personal Area Network (WPAN), a Wireless Wide Area Network (WWAN), WiMAX, IEEE 802.16 (Worldwide Interoperability for Microwave Access (WiMAX)), 3G/4G/LTE cellular communication methods, NFC (Near Field Communication), parallel interfaces, RF communication methods, infrared communication methods, or in any other suitable manner.

With reference to FIGS. 1A-3, aquatic vehicle 100 generally includes a body 110 configured to float in an aquatic environment and support the various components of aquatic vehicle 100 thereon or therein. For example, body 110 of aquatic vehicle 100 may include one or more hulls and may be configured as a surfboard, floating platform, monohull boat, catamaran boat, or in any other suitable manner. Aquatic vehicle 100 further includes a drive sub-system 120, a power sub-system 130, a sensor sub-system 140, an imaging sub-system 150, and/or a microcontroller 160. The drive sub-system may include, for example, one or more thrusters 122 depending from the body 110, one or more motors 124 configured to drive the one or more thrusters 122, and one or more drive controllers 126. The power sub-system 130 may include, for example, one or more power sources, e.g., a primary power source 132 and a secondary power source 134. The power sub-system 130 may further include one or more solar panels 136. The sensor sub-system 140 may include one or more sensors such as, for example, a sonar sensor 142, air and/or water temperatures sensor 144a, biosensor 144b, pressure sensor 144c, oxygen concentration sensor 144d, and/or any other suitable sensor(s). The sensor sub-system 140 further includes a GPS module 146. The imaging sub-system 150 may include a video and/or still visible image camera 152, thermal camera, radiation camera, ultrasound imager, etc. Additional or alternative sub-systems of aquatic vehicle 100 are also contemplated, as is a modular configuration enabling customization of a particular set of sub-systems for use with aquatic vehicle 100 depending upon a particular purpose.

Drive sub-system 120 enables the powered propulsion of aquatic vehicle 100 through an aquatic environment and, as noted above, includes one or more thrusters 122 depending from the body 110, one or more motors 124 configured to drive the one or more thrusters 122, and one or more drive controllers 126. As an alternative or in addition to the one or more thrusters 122, other suitable propulsion devices may be utilized such as, for example, propellers, paddle wheels, etc. The one or more motors 124 may be brushless electric DC motors or other suitable motors configured to collectively or independently drive thrusters 122. Thrusters 122 may be operably positioned relative to body 110 and independently activatable to enable navigation of aquatic vehicle 100 in a desired manner based on the selective activation and speed thereof, may be rotatable to facilitate navigation of aquatic vehicle 100 in a desired direction, and/or other suitable steering mechanisms (not shown) may be provided. Stabilization fins, rudders, and/or other suitable structures may be coupled to body 110 to facilitate balance and steering. The controllers 126 may be or include one or more Electronic Speed Controllers (ESCs) controlled by the microcontroller 160 to drive the motors 124 and, thus, the thrusters 122 at desired speed(s) and, as noted above, may operate collectively or independently. Drive sub-system 120 may be controlled using a GPS-based feedback system, autonomously or manually, to achieve a desired travel path of aquatic vehicle 100 within the aquatic environment such as, for example, to substantially sweep a desired portion of the aquatic environment, an area of interest within the aquatic environment, or the substantial entirety of the aquatic environment.

Power sub-system 130 is configured to power the on-board electrical components of aquatic vehicle 100, for example: drive sub-system 120, sensor sub-system 140, imaging sub-system 150, and microcontroller 160. As noted above, power sub-system 130 may include a primary power source 132 having, for example, one or more batteries (e.g., Li-ion batteries), a secondary power source 134 having, for example, one or more batteries (e.g., Li-ion batteries), and/or one or more solar panels 136. Power sub-system 130 may further include primary and secondary power management systems 133, 135 configured to control the primary and secondary power sources 132, 134, respectively, a solar controller 137 for controlling the solar panel(s) 136, and a switch assembly 138 configured to enable switching (manual or automatic) between the primary and secondary power sources 132, 134 as needed to provide sufficient power to the various on-board electrical components of aquatic vehicle 100. Solar panels 136 may generate electrical energy from daylight that is utilized to charge first and/or second power sources 132, 134 depending upon relative states of charge thereof, according to an energy storage algorithm implemented by solar controller 137, or in any other suitable manner. Primary and secondary power sources 132, 134 and/or other components of power sub-system 130 may be housed at least partially within a protective enclosure 131 (FIGS. 1A-1D) that may be at least partially waterproof or water resistant to inhibit water damage to the components therein. Primary power source 132 may be configured to provide sufficient power to operate aquatic vehicle 100 for at least 24 hours without additional power supplied from secondary power source 134 or solar panels 136. Secondary power source 134 may be an emergency back-up power source or may be otherwise configured, e.g., to provide a power boost as needed in certain conditions.

Sensor sub-system 140 includes a sensor array having one or more sensors such as, for example, a sonar sensor 142, air and/or water temperature sensors 144a, a biosensor 144b, a pressure sensor 144c, an oxygen concentration sensor 144d, and/or any other suitable sensor(s), e.g., sensor(s) for sensing water pH, concentration of other chemical elements and/or compounds, the presence and/or concentration of one or more different types of biological matter, one or more properties of water and/or soil, etc. Proximity sensors are also contemplated, e.g., to facilitate navigation and collision avoidance. The sensors of sensor sub-system 140 may be disposed on an underside of body 110, e.g., as with sonar sensor 142, may be disposed atop body 110, e.g., as with air temperature sensor 144a, or may be disposed in any other suitable position to enable sensing underwater, at the surface of the water, and/or above-water. As can be appreciated, the particular sensor(s) or combination of sensors utilized and the configuration and arrangement thereof may depend on the aquatic environment being monitored, the purpose of the monitoring, etc.

Sensor sub-system 140 further includes a GPS module 146 configured to communicate with a GPS satellite 300 (FIG. 2), to enable determination and tracking of the position of aquatic vehicle 100. As detailed below, GPS module 146 not only facilitates navigation of aquatic vehicle 100 but also enables correlation of the data collected via sensor sub-system 140 with a particular location, e.g., to enable mapping of sensor data across the portion, area of interest, or substantial entirety of the aquatic environment.

As an addition or alternative to sensors, aquatic vehicle 100 may include testing equipment (not shown) and/or sampling equipment (not shown) configured to enable testing and/or sampling of water; plants, animals, bacterial, and other biological mater; soil; etc. Such equipment may include robotic components and/or other suitable features to carry out autonomous testing and/or sampling. Similarly as above with respect to the sensors, the tests and/or samples may be correlated with the particular locations where they were conducted and/or retrieved, e.g., based on location information provided by GPS module 146.

Imaging sub-system 150 may include, for example, a video and/or still visible image camera 152, thermal camera, radiation camera, ultrasound imager, etc. The video and/or images obtained from imaging sub-system 150 may be correlated with the particular locations from which they were obtained, e.g., based on location information provided by GPS module 146.

Microcontroller 160 is configured to control the on-board sub-systems 120-150 of aquatic vehicle 100 and to enable communication with remote computer 200, satellite 300, and/or cloud device 400. Microcontroller 160 includes a processor to process data, a memory in communication with the processor to store data, and an input/output unit (I/O) to interface the processor and/or memory to other devices both onboard, e.g., sub-systems 120-150, and remote, e.g., computer 200, satellite 300, and/or cloud device 400. The memory can include and store processor-executable code, which when executed by the processor, configures the data processing unit to perform various operations, e.g., such as receiving information, commands, and/or data, processing information and data, and transmitting or providing information/data to another device. In some implementations, the data processing unit can transmit raw or processed data to a computer system or communication network accessible via the Internet (e.g., the cloud) that includes one or more remote computational processing devices (e.g., servers in the cloud). To support various functions of the microcontroller 160, the memory can store information and data, such as instructions, software, values, images, and other data processed or referenced by the processor. For example, various types of Random Access Memory (RAM) devices, Read Only Memory (ROM) devices, Flash Memory devices, and other suitable storage media can be used to implement storage functions of the memory. The I/O of the microcontroller 160 can interface the data processing unit with a wireless communications unit to utilize various types of wired or wireless interfaces compatible with typical data communication standards, for example, which can be used in communications of the microcontroller 160 with other devices via any of the communication methods noted above. The I/O of the microcontroller 160 can also interface with other external interfaces, sources of data storage, and/or visual or audio display devices, etc. to retrieve and transfer data and information that can be processed by the processor, stored in the memory, or exhibited on an output unit, e.g., a visual display, speaker, printer, etc.

Microcontroller 160 and/or other sensitive electronics may be housed at least partially within a protective enclosure 161 (FIGS. 1A-1D) that may be at least partially waterproof or water resistant to inhibit water damage to the components therein.

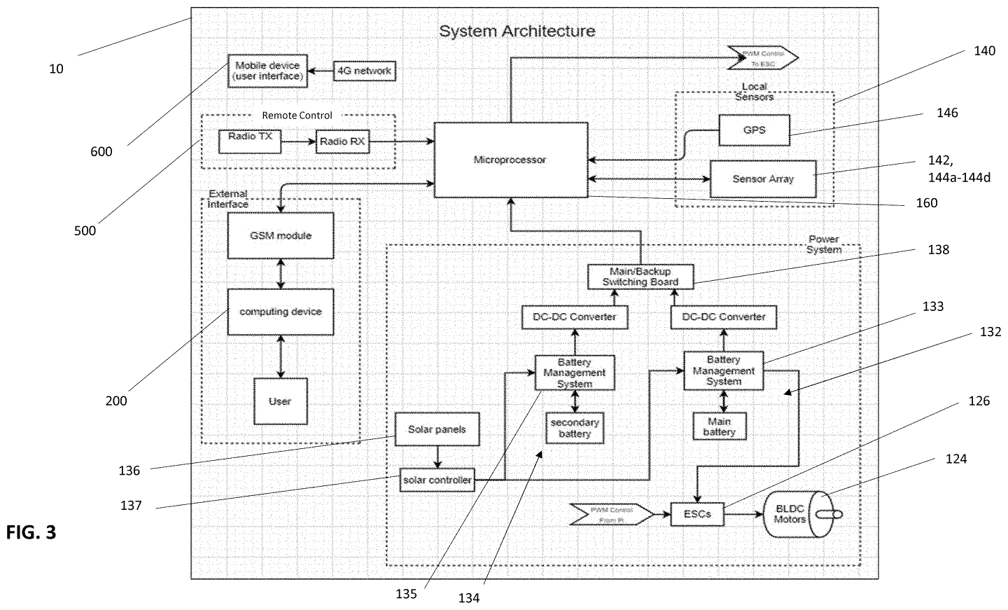

With reference to FIGS. 2 and 3, in aspects, control of some or all of the sub-systems 120-150 of aquatic vehicle 100 may be performed remotely, e.g., via a user interface associated with remote computer 200 and communicating via any suitable method, and/or may be performed remotely via a remote control device 500, e.g., a joystick or other handheld controller utilizing RF communication. Alternative or additional remote computer(s) may be provided such as, for example, a tablet or mobile phone 600 communicating over a cellular network or in accordance with any of the communication methods noted above.

The remote devices 200, 400, 500, and/or 600 may be utilized on the input side, e.g., to provide instructions to enable the control of some or all of the sub-systems 120-150 of aquatic vehicle 100; as part of a feedback loop to facilitate real-time control; and/or on the output side, e.g., to enable processing of collected data and output of the same in a presentable format, e.g., as a map, graph, chart, table, etc.

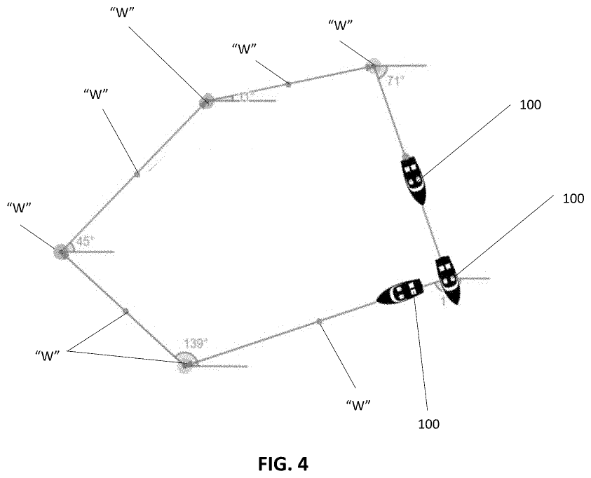

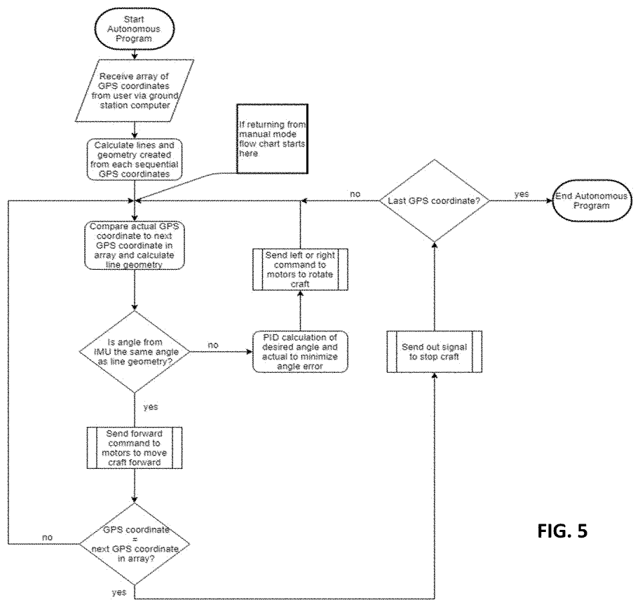

Turning to FIGS. 4-6, with respect to navigation of aquatic vehicle 100, aquatic vehicle 100 may operate in a manual mode, e.g., wherein a user directs aquatic vehicle 100 in a desired direction and/or to a desired location in real-time, or in an autonomous mode. In the autonomous mode, aquatic vehicle 100 may be configured to follow a pre-determined path based on a pre-determined series of input waypoints “W” without further input from a user. Alternatively or additionally, aquatic vehicle 100 may be configured to determine (or communicate with a device, e.g., remote computer 200 or cloud 400 (FIG. 2), that is configured to determine) a series of waypoints “W” in order to sweep an input pre-determined area(s) to be monitored by aquatic vehicle 100. Further still, aquatic vehicle 100 may be configured for (or in communication with a device, e.g., remote computer 200 or cloud 400 (FIG. 2), configured for) target-based navigation; that is, wherein waypoints “W” (or additional waypoints “W” if another navigation mode is already running) are assigned automatically in order to sweep an identified area of interest and/or a surrounding area. The area of interest may be identified by a user, or may be identified based on feedback from one or more of the sensors of sensor sub-assembly 140 (FIGS. 1A-3). For example, an area may be designated as an area of interest where a particular bathymetric feature is identified, where an (absolute or relative) threshold oxygen concentration is reached, where presence of biological matter (or a certain biological matter or concentration thereof) is detected, etc. Other suitable methods for manual, autonomous, and/or hybrid navigation are also contemplated.

FIGS. 4 and 5, more specifically, illustrate feedback-based navigation of aquatic vehicle 100 to enable aquatic vehicle to autonomously follow predetermined path created by the user, e.g., via a set of waypoints “W” (corresponding to GPS coordinates) input at the start of operation. As an alternative to user-input waypoints “W,” waypoints “W” may automatically be determined utilizing a suitable program, algorithm, machine learning, etc., to facilitate navigation to the input waypoints “W” and/or to achieve a desired result input by the user, e.g., to monitor a particular area of the aquatic environment, to follow a shoreline or other geographical feature, etc. The waypoint receipt or generation may be performed locally on aquatic vehicle 100 via microcontroller 160 or remotely, e.g., on remote computer 200, and communicated to aquatic vehicle 100.

If necessary, additional waypoints “W” between the input or determined waypoints “W” may be added to facilitate navigation. For example, a line may be drawn from each input or determined waypoint “W” to the subsequent waypoint “W” and then multiple intermediate waypoints “W” can be generated on that line creating a path of multiple discrete waypoints “W” between the two input or determined waypoints “W.” In aspects, rather than a line, any other suitable curve or pattern between the waypoints “W” may be followed, e.g., a sine-wave shape path, zig-zag path, etc. Once the lines (or curves or patterns) have been established, reference angles between the waypoints “W” can be generated to enable GPS feedback-based control to ensure the aquatic vehicle 100 follows the assigned path. More specifically, feedback-control is run to ensure aquatic vehicle 100 is oriented at the proper angle and, once oriented at the proper angle, aquatic vehicle 100 is advanced along the travel path from the current waypoint “W” to the next waypoint “W,” and, thereafter, the orientation angle of aquatic vehicle 100 is checked and corrected if needed before the aquatic vehicle 100 proceeds along the travel path to the next waypoint “W.”

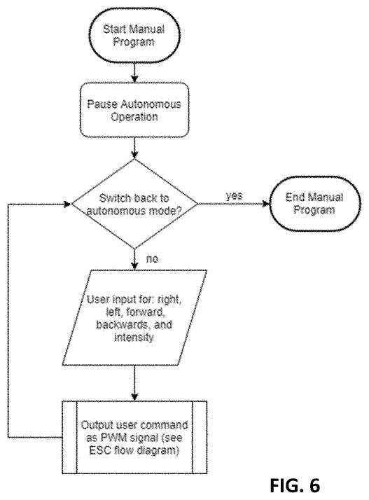

Referring to FIG. 6, a method of manual navigation of aquatic vehicle 100 is shown wherein it is first ensured that autonomous operation is not running (and has not re-started) to avoid potential conflicting instructions relayed to aquatic vehicle 100. Once it is determined that only the manual mode is running, aquatic vehicle 100 is driven in direction and/or speed based on user input received, e.g., from remote control device 500 (FIG. 3). The user may utilize GPS feedback information, e.g., on a display associated with remote control device 500 (FIG. 3), remote computer 200 (FIG. 3), and/or any other suitable display device, to facilitate manual navigation. Alternatively or additionally, the user may utilize video from imaging sub-system 150 (displayed on any suitable display such as those noted above), or may manually navigate in any other suitable manner. If autonomous operation is initiated at any point, aquatic vehicle 100 switches over to the autonomous mode of operation, although other hierarchy schemes are also contemplated.

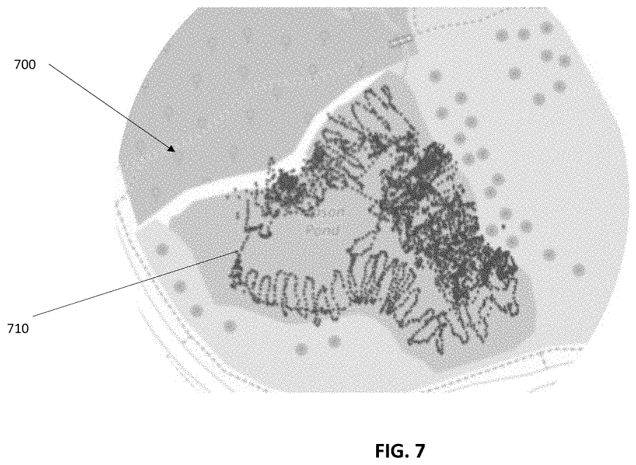

Turning to FIG. 7, in conjunction with FIGS. 2 and 3, a map 700 is shown illustrating a travel path 710 of aquatic vehicle 100 within an aquatic environment, e.g., a pond. Travel path 710 may be achieved using a manual operating mode, in any of the autonomous operating modes detailed above, or in any other suitable manner. GPS feedback information relayed from aquatic vehicle 100 to remote computer 200 or any other suitable device or combination of devices may be utilized to produce map 700 and display the same to a user, e.g., on a display associated with remote computer 200 (FIG. 2) or other suitable display. Travel path 710 may be represented by a series of dots (as shown) or may be illustrated as a continuous line. In aspects where a dotted travel path 710 is provided, the dots may represent waypoints and/or may illustrate discrete sensor data points; that is, locations where sensor data was obtained. This information regarding sensor data points, whether displayed on map 700 or not, is useful in that it enables correlation of the senor data points with particular GPS coordinates, thus enabling mapping or other location-specific data processing of sensor data in connection with GPS data, as detailed below.

Sensor data may be obtained at each waypoint, continuously between waypoints, intermittently between waypoints, and/or in any other suitable manner. With regard to sensors that require aquatic vehicle 100 to remain substantially stationary and/or operate at a reduced speed, aquatic vehicle 100 may be automatically controlled as it travels along travel path 710 to stop and/or reduce speed to enable such sensor measurements at prescribed intervals or otherwise to enable capture of sensor data along travel path 710 in a suitable manner.

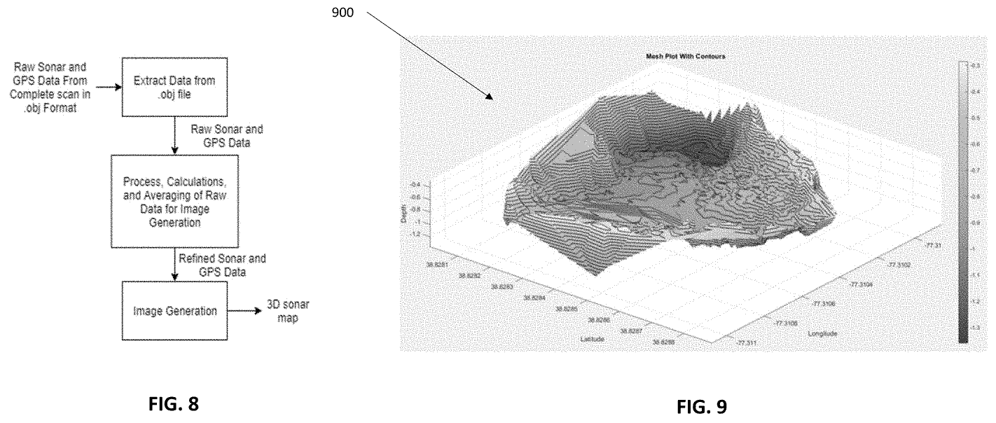

An example method and resultant 3D map for data processing of sensor data, e.g., sonar data from sonar sensor 142 (FIG. 2), in correlation with GPS data, e.g., from GPS module 146, obtained by aquatic vehicle 100 while navigating travel path 710 (FIG. 7) are shown in FIGS. 8 and 9, respectively. Referring also to FIGS. 2 and 3, with respect to the method illustrated in the flow diagram of FIG. 8, the raw sonar data and corresponding GPS data compiled by aquatic vehicle 100 (e.g., by microcontroller 160 based on communicating with sonar sensor 142 and GPS module 146) is transmitted from microcontroller 160 of aquatic vehicle 100 to remote computer 200 or any other suitable device or combination of devices. The data may be transmitted continuously during operation of aquatic vehicle 100 or may be stored locally in microcontroller 160 of aquatic vehicle 100 for transmission intermittently or upon completion of the operation of aquatic vehicle 100. Regardless of the timing of transmission, the transmitted data may be extracted from its transmission file format, if necessary, such that the raw sonar and GPS data is transformed into a format usable by remote computer 200. Remote computer 200, more specifically, processes the raw sonar and GPS data to produce refined sonar and GPS data that may be utilized to generate a suitable output correlating the sonar and GPS data such as, for example, a 3D bathymetry map 900, as shown in FIG. 9. As can be appreciated, the 3D bathymetry map 900 represents a portion of the aquatic environment, e.g., the pond illustrated in FIG. 7, that substantially corresponds to the travel path 710 (FIG. 7) navigated by aquatic vehicle 100. In other words, the area represented on the 3D map 900 of FIG. 9 as well as the granularity of such data represented thereby, are based upon the travel path 710 (FIG. 7) navigated by aquatic vehicle 100 (which defines the area swept or covered by aquatic vehicle) and the number and frequency of sensor measurements taken along the travel path 710 (FIG. 7). Accordingly, the area of coverage and granularity of data can be customized by utilizing an appropriate travel path 710 (FIG. 7).

Remote computer 200 (or other computing device(s) utilized) may include one or more processors, memories in communication with the processor(s), I/O(s), and display(s) to provide the above-detailed functionality. The processor(s), memory(s), I/O(s) and display(s) may be configured similarly as detailed above, e.g., with respect to microcontroller 160 (FIG. 3) or in any other suitable manner.

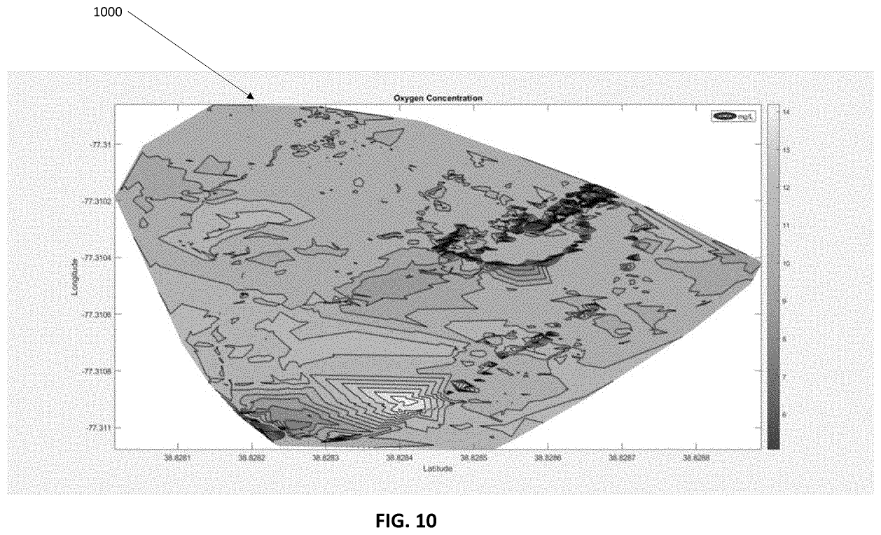

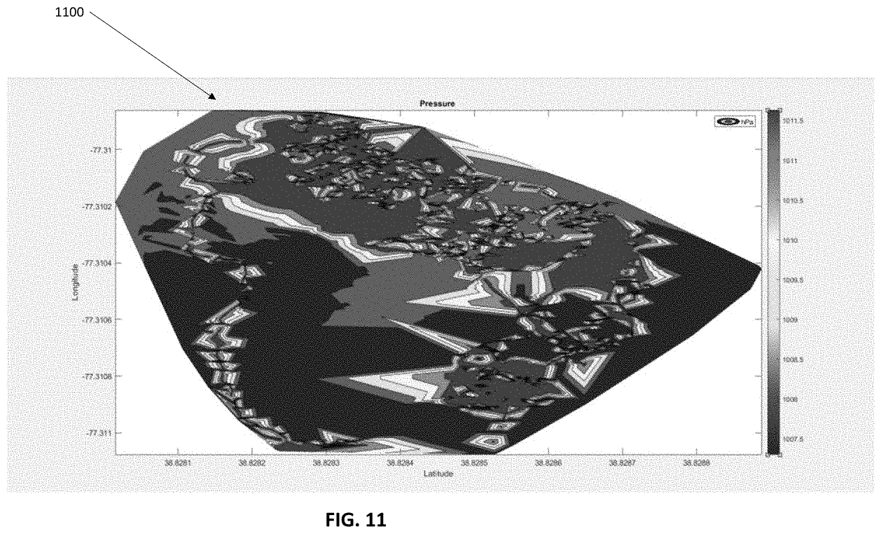

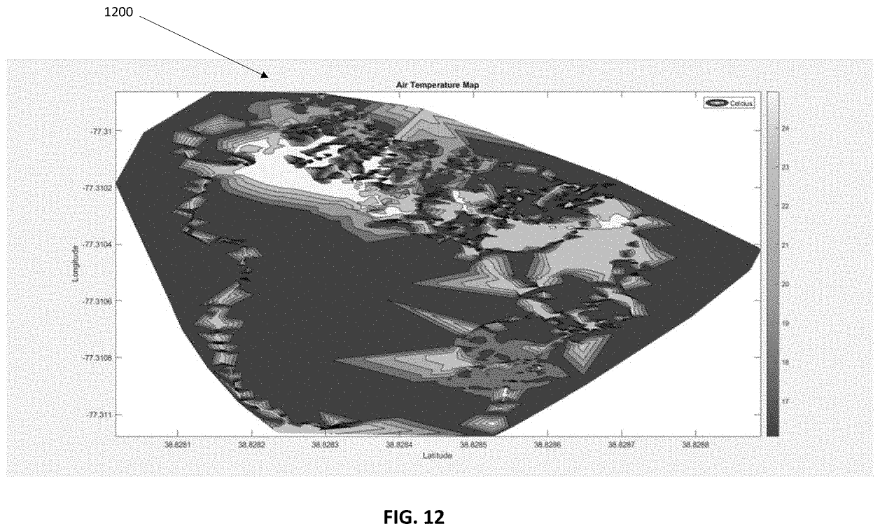

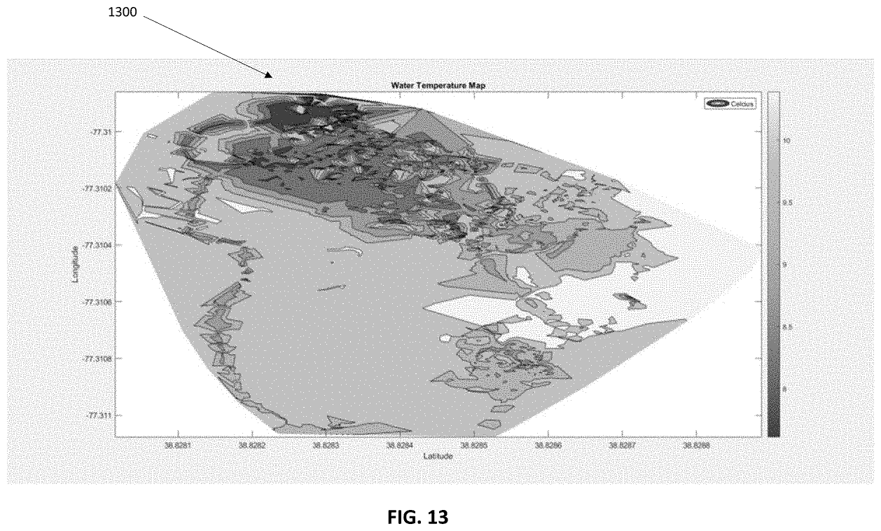

Although the capture, compiling, transmitting, receiving, and processing of data to correlate sensor data with GPS data to produce a map (or other suitable output) is detailed above with respect to sonar data, the present disclosure is not limited thereto as the sensor data from any of the other sensors of aquatic vehicle 100 may likewise be utilized in a similar manner. For example, FIG. 10 illustrates an oxygen concentration map 1000 generated based upon sensed oxygen concentration data correlated with GPS data obtained from navigation of aquatic vehicle 100 along a travel path. As another example, FIG. 11 illustrates a pressure map 1100 generated based upon sensed pressure data correlated with GPS data obtained from navigation of aquatic vehicle 100 along a travel path. Still other examples are illustrated in FIGS. 12 and 13, which respectively provide air and water temperature maps 1200, 1300 based upon sensed air and water temperature data correlated with GPS data obtained from navigation of aquatic vehicle 100 along a travel path. Other suitable sensors and/or outputs correlating the resultant data with GPS data and/or data from other sensors obtained from navigation of aquatic vehicle 100 along a travel path are also contemplated.

In aspects, rather than providing an aquatic vehicle for use in aquatic environments, the vehicles, systems, and methods of the present disclosure may be adapted for use in an air environment, a land environment, or an amphibious environment. As such, as an alternative or in addition to thrusters 122 (FIGS. 1A-1D), wings, propellers, wheels, treads, or other suitable air and/or land-traversing equipment may be provided to enable the mapping, sensing, and/or monitoring of air, land, and/or amphibious environments.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

What is claimed is:

1. An aquatic environment monitoring system, comprising:
an aquatic vehicle including a body supporting a drive sub-system configured to drive the aquatic vehicle along a travel path, at least one sensor configured to obtain a plurality of sensor data points at a plurality of different locations along the travel path, a GPS module configured to track movement of the aquatic vehicle along the travel path, and a microcontroller including a processor and memory storing instructions to be executed by the processor, the microcontroller configured to compile the sensor data points and GPS location data corresponding to a location where that sensor data point was obtained for each sensor data point, and to transmit the compiled data; and
a remote computer including a processor and memory storing instructions to be executed by the processor, the remote computer configured to receive the compiled data and process the compiled data to provide an output correlating the sensor data points with the GPS location data.

2. The aquatic environment monitoring system according to claim 1, wherein the output is a visual output.

3. The aquatic environment monitoring system according to claim 2, wherein the visual output is a map.

4. The aquatic environment monitoring system according to claim 1, wherein the at least one sensor includes a sonar sensor and wherein the sensor data points are sonar data points.

5. The aquatic environment monitoring system according to claim 4, wherein the output includes a bathymetry map.

6. The aquatic environment monitoring system according to claim 1, wherein the at least one sensor includes at least one of: a pressure sensor, an oxygen concentration sensor, an air temperature sensor, or a water temperature sensor and wherein the sensor data points are at least one of: pressure data points, oxygen concentration data points, air temperature data points, or water temperature data points, respectively.

7. The aquatic environment monitoring system according to claim 4, wherein the output includes a map illustrating sensor data point values at corresponding GPS locations.

8. The aquatic environment monitoring system according to claim 1, further comprising a remote controller configured to enable a user to remotely manually control the drive system to drive the aquatic vehicle at a desired speed and direction to define the travel path.

9. The aquatic environment monitoring system according to claim 1, wherein the travel path is pre-determined and wherein the microcontroller is configured to control the drive sub-system in accordance with GPS feedback data from the GPS module to autonomously drive the aquatic vehicle along the travel path.

10. The aquatic environment monitoring system according to claim 9, where the travel path is pre-determined by a plurality of user-input waypoints.

11. The aquatic environment monitoring system according to claim 1, wherein the travel path is determined by the microcontroller or the remote computer based on a user-input corresponding to a desired area to be monitored, and wherein the microcontroller is configured to control the drive sub-system in accordance with GPS feedback data from the GPS module to autonomously drive the aquatic vehicle along the determined travel path.

12. The aquatic environment monitoring system according to claim 11, wherein the travel path is determined by a plurality of generated waypoints.

13. The aquatic environment monitoring system according to claim 1, further comprising at least one power source disposed on the body of the aquatic vehicle for powering the aquatic vehicle.

14. The aquatic environment monitoring system according to claim 13, wherein the at least one power source includes at least one of: a primary and secondary power source or at least one power source and at least one solar panel.

15. The aquatic environment monitoring system according to claim 1, wherein the drive sub-system includes at least one thruster, at least one motor configured to drive the at least one thruster, and at least one drive controller configured to control the at least one motor.

16. A method of aquatic environment monitoring, comprising:
driving an aquatic vehicle along a travel path;
sensing a plurality of sensor data points at a plurality of different locations along the travel path;
tracking movement of the aquatic vehicle along the travel path;
compiling, utilizing an on-board microcontroller of the aquatic vehicle including a processor and memory storing instructions to be executed by the processor, the sensor data points with GPS location data corresponding to a location where each of the sensor data points was obtained;
transmitting the compiled data from the aquatic vehicle to a remote computer including a processor and memory storing instructions to be executed by the processor;
receiving the compiled data at the remote computer; and
processing the compiled data at the remote computer to provide an output correlating the sensor data points with the GPS location data.

17. The method according to claim 16, wherein providing the output includes generating a map illustrating sensor data point values at corresponding GPS locations.

18. The method according to claim 16, wherein the plurality of sensor data points represent at least one of: sonar data, pressure data, oxygen concentration data, air temperature data, or water temperature data.

19. The method according to claim 16, wherein driving the aquatic vehicle includes receiving instructions from a remote controller to drive the aquatic vehicle at a desired speed and direction to define the travel path.

20. The method according to claim 16, wherein driving the aquatic vehicle includes autonomously driving the aquatic vehicle along the travel path using GPS feedback data and at least one of: pre-determined waypoints or generated waypoints.
